(19) United States
(12) Patent Application Publication
(10) Pub. No.: US 2013/0346766 A1
(43) Pub. Date: Dec. 26, 2013

(54) POWER CONTROL DEVICE AND POWER CONTROL METHOD

(71) Applicant: PANASONIC CORPORATION, Osaka (JP)

(72) Inventor: Takenobu TANI, Kyoto (JP)

(73) Assignee: PANASONIC CORPORATION, Osaka (JP)

(21) Appl. No.: 13/972,468

(22) Filed: Aug. 21, 2013

Related U.S. Application Data
(63) Continuation of application No. PCT/JP2011/003668, filed on Jun. 28, 2011.

(30) Foreign Application Priority Data
Feb. 28, 2011 (JP) 2011-043196

(51) Int. Cl. G06F 1/32

(52) U.S. Cl. CPC G06F 1/3203
USPC 713/300

(57) ABSTRACT

Logical processors are grouped into logical processor groups. A power control device includes: a power state information determining unit which, when one of the logical processors assigned to the physical processor is replaced with another one of the logical processors, and based on power state information indicating power consumption of another physical processor to which the logical processors that belong to a target logical processor group are assigned, determines power state information to be used when the replacing logical processor is assigned to the physical processor, the target logical processor group being one of the logical processor groups and including the replacing logical processor; and a power state changing unit which changes power to be supplied to the physical processor based on the power state information determined by the power state information determining unit.

### CROSS REFERENCE TO RELATED APPLICATIONS

This is a continuation application of PCT International Application No. PCT/JP2011/003668 filed on Jun. 28, 2011, designating the United States of America, which is based on and claims priority of Japanese Patent Application No. 2011-043196 filed on Feb. 28, 2011. The entire disclosures of the above-identified applications, including the specifications, drawings and claims are incorporated herein by reference in their entirety.

### FIELD

The present disclosure relates to a power control device and power control method for determining power state information indicating a power state of a physical processor in a multiprocessor.

### BACKGROUND

In recent years, there have been increasing demands for more and more various features for digital devices such as digital TVs, video recorders, or cellular phones. The features are digital processing capabilities including voice processing, audio processing, video processing, or video coding, graphical user interface (GUI)-based operations, or Web-browser viewing capabilities on the Internet. Such processing is typically executed by information processing devices such as microprocessors. In order to improve the processing capabilities in conformity with an increase in demands for applications, the microprocessors are acquiring higher operation frequencies, multithreading capabilities, and multiple cores.

Such processing is typically executed by information processing devices such as microprocessors. As demands for applications increase, an information processing device has had a larger circuit, a higher operation frequency, or more processors. Consequently, power consumption of the device has continued to increase.

The increase in power consumption causes environmental problems due to energy consumption, and a shorter operation time for a battery and, as well, a device. In addition, the increase in power consumption causes serious problems such as malfunction due generated heat, an increasing cost for a cooling device, and lowering reliability after a long period of use.

In order to address these problems, various measures have been devised for reducing power consumption. One of such measures in recent years is a power control technique to change a frequency and a voltage state, depending on an average load status of a running processor in a long cycle (see Patent Literature 1, for example).

On the other hand, as a new attempt to achieve a high processing capability and software productivity at a low cost, a virtual multiprocessor has become in practical use. In a multiprocessor, the virtual multiprocessor executes multiple operating systems (OS) (see Patent Literatures 2 and 3).

### CITATION LIST

### Patent Literature

[PTL 1] WO 2006/117950
[PTL 2] Japan Patent No. 3927533
[PTL 3] Japan Patent No. 4181554

### SUMMARY

### Technical Problem

In a virtual multiprocessor, multiple OSes are executed on each of physical processors. Hence, each of the physical processors has multiple logical processors assigned by time sharing. Here, each logical processor might have a different processing load.

Conventional power control techniques, however, are executed for each physical processor. Hence, when logical processors, each having a different processing load, are assigned to a single physical processor by time sharing, the conventional power control techniques cannot follow variations of the processing loads caused when the logical processors are switched therebetween. Consequently, the techniques fail to carry out optimum power control.

One non-limiting and exemplary embodiment provides a power control device to achieve optimum power control for a virtual processor.

### Solution to Problem

A power control device according to an aspect of the present invention controls power consumption of a physical processor in a virtual processor in which logical processors are each assigned to the physical processor by time sharing to execute processes on the logical processors, the power consumption dynamically changing depending on a processing amount. The logical processors are grouped into logical processor groups. The power control device includes: a power state information determining unit which, when one of the logical processors assigned to the physical processor is replaced with another one of the logical processors, and based on power state information indicating power consumption of another physical processor to which the logical processors that belong to a target logical processor group are assigned, determines power state information to be used when the replacing logical processor is assigned to the physical processor, the target logical processor group being one of the logical processor groups and including the replacing logical processor; and a power state changing unit which changes power to be supplied to the physical processor based on the power state information determined by the power state information determining unit.

The power control device separates logical processors into groups in each of which the grouped logical processors are mutually correlated so that the grouped logical processors execute processing on a comparable level. Then, based on power state information on the logical processors which belong to the target logical processor group, the power control device determines power state information on the replacing logical processor (power state information on a physical processor to which the replacing logical processor is to be assigned). Hence, even though processing loads differ among multiple logical processors each to be assigned to one of the physical processors by time sharing, the power control device can follow the change of a processing load due to switching logical processors and implement optimum power control.

The power state information determining unit may determine the power state information on the replacing logical processor based on power state information on a logical processor which is (i) included in the logical processors that belong to the target logical processor group and (ii) different from the replacing logical processor.

In the case where there is a correlation among the logical processors, such a structure makes it possible to predict power state information using the correlation of the power state information.

The power control device may further include a power state control information storage unit which stores intra-logical-processor-group prediction permission information indicating, in determining for each of the logical processor groups power state information on a logical processor which belongs to the each logical processor group, permission of a use of power state information on a logical processor which belongs to the each logical processor group and is different from a logical processor to be assigned to the physical processor. With reference to the intra-logical-processor-group prediction permission information stored in the power state control information storage unit, the power state information determining unit may determine the power state information on the replacing logical processor based on the power state information on a logical processor which is (i) included in the logical processors that belong to the target logical processor group and (ii) different from the replacing logical processor, only when intra-logical-processor-group prediction permission information indicates the permission.

The power state information determining unit may determine an average value indicated by the power state information on the different logical processor as a value indicated by the power state information on the replacing logical processor.

The power control device may further include a power state control information storage unit which stores information for inter-logical-processor-group prediction on logical processor group to be predicted which (i) is referred to in determining for each of the logical processor groups power state information on a logical processor which belongs to the each logical processor group and (ii) indicates a logical processor group that is different from the each logical processor group. The power state information determining unit may determine the power state information on the replacing logical processor based on (i) power state information on a logical processor included in the logical processors and belongs to the logical processor group indicated by the information for inter-logical-processor-group prediction on logical processor group to be predicted and (ii) power state information on a logical processor which is (i) included in the logical processors that belong to the target logical processor group and (ii) different from the replacing logical processor.

Such a structure makes it possible to determine power state information on the replacing logical processor, using power state information on a logical processor (i) correlated with a logical processor included in the target logical processor group and (ii) included in another logical processor group. For example, such processing is effective when two logical processor groups include logical processors running on the same OS.

The power state information determining unit may determine the power state information on the replacing logical processor based on previous power state information on the replacing logical processor.

It is only a replacing logical processor, which belongs to the target logical processor group, that is assigned to the physical processor. When a logical processor, which is other than the replacing logical processor that belongs to the target logical processor group, is not assigned to the physical processor, the power state information determining unit determines the current power state information on the replacing logical processor using at least past power state information on the replacing logical processor, so that false predictions can be reduced to the minimum.

When values which are indicated by the previous power state information on the logical processors that belong to the target logical processor group and are assigned to the other physical processor are monotonically increase or decrease over temporal progress, the power state information determining unit may determine the power state information on the replacing logical processor by extrapolating the values.

Such a structure makes it possible to determine appropriate power state information when a processing load is gradually increasing or decreasing in a logical processor group.

The power control device may further include a power state control information storage unit which stores power prediction history information indicating whether or not the power state information on the physical processer is true, the power state information being determined for each of the logical processor groups when a logical processor which belongs to the each logical processor group is assigned to the physical processor. With reference to the power prediction history information stored in the power state control information storage unit, the power state information determining unit may determine the power state information on the replacing logical processor only when the power state information on the other physical processor for the target logical processor group is true.

In the case where the determined power state information is false, the power state information determining unit may prohibit the prediction of the power state information. Such a feature makes it possible to determine power state information, while reducing unnecessary failures in prediction of power state information.

The power control device may further include a power state control information storage unit which stores for each of the logical processor groups condition information indicating responsiveness of processing to be executed by a logical processor which belongs to the each logical processor group. Based on (i) power state information on a logical processor which is included in the logical processors that belong to the target logical processor group and is different from the replacing logical processor and (ii) the condition information for the target logical processor group stored in the power state control information storage unit, the power state information determining unit may determine the power state information on the replacing logical processor, the power state information indicating that power is greater as the responsiveness indicated by the condition information is higher.

When a logical processor to be assigned to a physical processor is one in a logical processor group for which high responsiveness is required, the power control device determines power state information to obtain greater power. Hence, the power control device can determine power state information which reflects responsiveness designated by the condition information.

The power control device may further include a power state control information storage unit which store for each of the logical processor groups information on applicability as emergency processor indicating whether or not highest responsiveness is required for processing to be executed by a logical processor which belongs to the each logical processor group. When the information on applicability as emergency processor requests the highest responsiveness for the target logical processor group stored in the power state control information storage unit, the power state information determining unit may determine a possible maximum value for power state information as a value indicated by the power state information on the replacing logical processor.

Such a structure allows a logical processor to be activated at the maximum power when the logical processor is an emergency processor which is required of the highest responsiveness.

It is noted that the present disclosure can be implemented not only in the form of the power control device including the above characteristic processing units but also a power control method including processing executed by the processing units in the form of steps. In addition, the present disclosure can be implemented in the form of a program to be executed on a computer either as the characteristic processing units included in the power control device or characteristic steps included in the power control method. As a matter of course, the program may be distributed via a non-transitory computer-readable recording medium such as a Compact Disc-Read Only Memory (CD-ROM) and a communications network such as the Internet.

### Advantageous Effects

The present disclosure successfully achieves optimum power control for a virtual processor.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 shows a typical software structure of a single physical processor.

FIG. 2 exemplifies time transition in power control of a single physical processor.

FIG. 3 shows a typical software structure of a multiprocessor including multiple physical processors.

FIG. 4 exemplifies time transition in power control of a multiprocessor.

FIG. 5 shows a typical software structure of a virtual multiprocessor.

FIG. 6 exemplifies time transition of assigned logical processors in a virtual multiprocessor.

FIG. 7 depicts a block diagram showing a configuration of a system large-scale integration (LSI) for a digital consumer appliance.

FIG. 8 exemplifies a processing load status for each of processors in a system LSI.

FIG. 9A exemplifies time transition of power state information on logical processors in a domain A of the virtual multiprocessor shown in FIG. 5.

FIG. 9B exemplifies time transition of power state information on logical processors in a domain B of the virtual multiprocessor shown in FIG. 5.

FIG. 9C exemplifies time transition of power state information on physical processors in the virtual multiprocessor shown in FIG. 5.

FIG. 10 exemplifies time transition of power control of a logical processor group when the entire the processing amount is monotonically increasing.

FIG. 11 depicts a block diagram showing a hardware structure of a multiprocessor system including a virtual multiprocessor according to the embodiment of the present disclosure.

FIG. 12 exemplifies a structure of logical processor group mapping information.

FIG. 13 exemplifies a structure of a physical processor power state chart.

FIG. 14 exemplifies a physical processor power state chart.

FIG. 15 exemplifies a structure of a logical processor power state chart.

FIG. 16 exemplifies a logical processor power state chart.

FIG. 17 exemplifies a structure of a voltage control device included in a power state changing device.

FIG. 18 exemplifies a structure of a clock control device included in the power state changing device.

FIG. 19 depicts a hierarchy diagram showing a software structure for a power control method of the multiprocessor system shown in FIG. 11.

FIG. 20 exemplifies a structure of a logical processor group corresponding chart.

FIG. 21 exemplifies a structure of a logical processor group power state control chart.

FIG. 22 exemplifies a structure of power state control information in the logical processor group power state control chart.

FIG. 23 exemplifies power state history information.

FIG. 24 depicts a flowchart of the power control method for the multiprocessor system according to the embodiment of the present disclosure.

FIG. 25 depicts another flowchart of the power control method for the multiprocessor system according to the embodiment of the present disclosure.

FIG. 26 depicts a flowchart showing details of power state prediction processing (the Step ZA2106 in FIG. 25).

FIG. 27 depicts a block diagram showing a logical control structure of the multiprocessor system according to the embodiment of the present disclosure.

FIG. 28 shows power state information on logical processors included in a single logical processor group.

FIG. 29 exemplifies time transition in power control of logical processors.

### DESCRIPTION OF EMBODIMENT

Before describing a multiprocessor according to the embodiment, the background of the present disclosure shall be described.

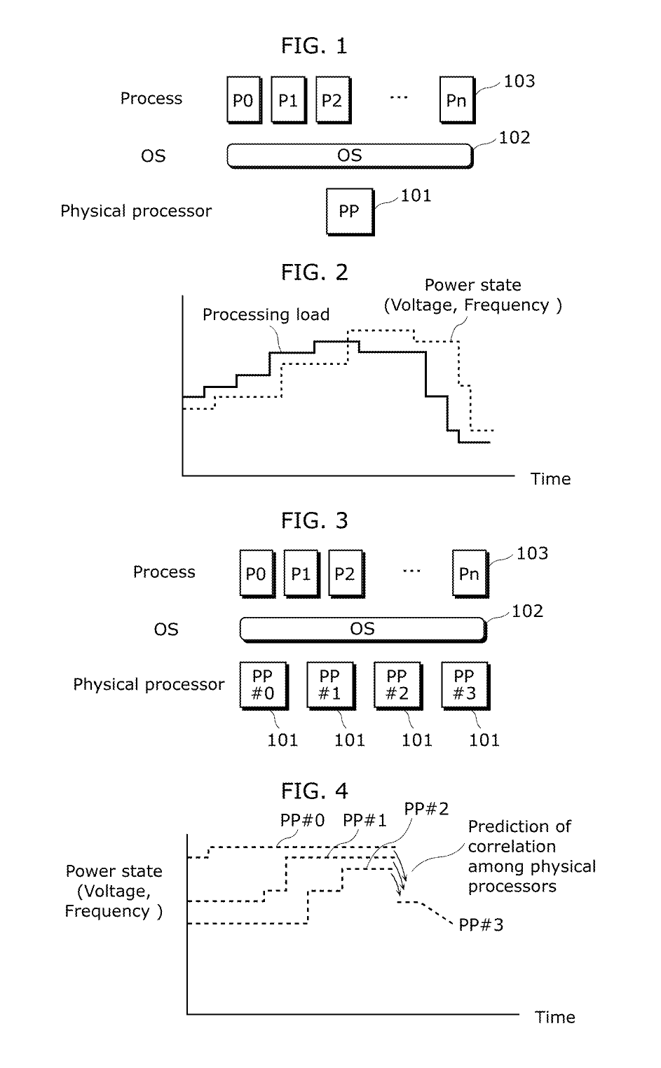

FIG. 1 shows a typical software structure of a single physical processor. FIG. 2 exemplifies time transition in power control of a single physical processor.

As shown in FIG. 1, an OS 102 is executed on a physical processor 101. The OS 102 manages resources, and provides a resource of the physical processor 101 to a process 103—that is what to execute software. In other words, the OS 102 assigns one of processes 103 (processes P0 to Pn) to the physical processor 101 by time sharing. Hence, the process 103 is executed on the physical processor 101 by time sharing.

Depending on a processing status of the process 103 executed on the physical processor 101, physical resources required of the physical processor 101 change. Such resources include frequencies and memories. In the case where the processing amount of the process 103 is large and a quick response is required of the process 103, the physical processor 101 needs to have a higher operation frequency and a larger capacity for its memory.

Here, a typical technique to reduce power consumption of the physical processor 101 is to change power conditions such as a frequency and a power-supply voltage of the physical processor 101, depending on the processing load of the physical processor 101.

FIG. 2 exemplifies how the OS 102 predictively changes the next power state information based on the present processing load status and a past processing load status of the physical processor 101 itself. Such a technique successfully implements more active and effective power control. It is noted that, in the embodiment, the power state information includes values each of which corresponds to one of operation voltages and one of operation frequencies of a physical processor (hereinafter referred to as “power state”). A higher power state (a greater power state) brings a higher operation voltage and operation frequency for the physical processor.

It is noted that the power control, which makes a frequency and a voltage dynamically variable, causes a problem in the implementation of real-time properties. Hence, for devices which requires real-time properties such as a digital TV and a cellular phone, the power control for the devices have to keep the devices from obstructions of the real-time processing.

Furthermore, in recent years, more and more processors are formed in a multiprocessing structure in order to enhance their processing capability. FIG. 3 shows a typical software structure of a multiprocessor including multiple physical processors. FIG. 4 exemplifies time transition in power control of the multiprocessor.

As shown in FIG. 3, multiple processes 103 (processes P0 to Pn) are executed on a multiprocessing OS 102 which commonly manages multiple physical processors 101 (physical processors PP#0 to PP#3). On each of the physical processors 101, a process 103 assigned by the OS 102 is executed.

Such a multiprocessor is capable of more active power control shown in FIG. 4, in addition to a power control method on the premise of a single processor shown in FIG. 2. In other words, power control for a physical processor 101 is executed with a reflection of the power state of another physical processor 101. Hence, each of the physical processors 101 can execute effective power control, taking advantage of the latest time information.

Specifically, as an example shown in FIG. 4, suppose there are three physical processors PP#0 to PP#2 each operating in a high power state because their processing loads are high. Described here is the case where the fourth physical processor PP#3 is activated in order to reduce the entire processing amount of the multiprocessor.

Here, the physical processor PP#3 used to stop even though the next power state of the physical processor PP#3 was predicted based on the present power state and a past power state of the physical processor PP#3. Hence, there is no prediction to be made to transfer a power state of the physical processor PP#3 to another power state in which the physical processor PP#3 can execute high-load processing at a time. Thus, the power state of the physical processor PP#3 may be predicted with reference to power states of other physical processors PP#0 to PP#2 operating in the same period of time. Such a prediction makes it possible to transfer a power state more quickly to a more appropriate power state. For example, the average value of the power states of the other physical processors PP#0 to PP#2 is predicted as a power state of the physical processor PP#3. Such a prediction makes it possible to activate the physical processor PP#3 in a power state in which the physical processor PP#3 can execute high-load processing.

Thus, in a multiprocessor, a power state to be predicted of a physical processor 101 can be predicted based on a power state of another physical processor 101 which correlates with the physical processor 101 of which power state is to be predicted. It is noted that the physical processors 101 that correlate each other are the ones having similar processing characteristics such as processing load, responsiveness required in processing, or details of processing.

Described next is a virtual multiprocessor.

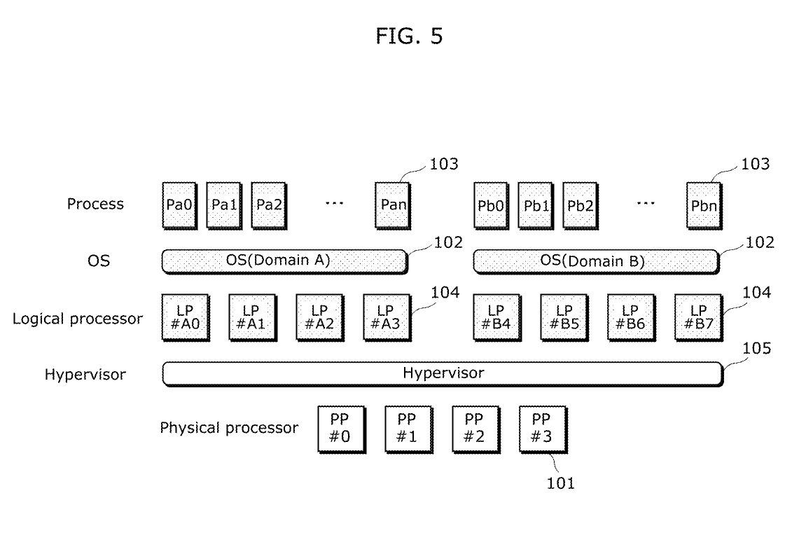

FIG. 5 shows a typical software structure of a virtual multiprocessor. Exemplified here is a case where there are two OS domains.

Each of the OSes 102 runs on a virtual processor which is called one of a logical processor 104 and a virtual processor 104. Each of the logical processors 104 operates as if the logical processor itself occupied a physical processor 101.

The logical processor 104 is assigned to a physical processor 101 by time sharing by software, hardware, or cooperation of software and hardware in a virtual layer. Such software, hardware, or the cooperation thereof are also called one of a hypervisor 105 and a virtual machine monitor 105.

As shown in FIG. 5, for example, the OS 102 in a domain A runs on four logical processors 104 (logical processors LP#A0 to LP#A3), and the OS 102 in a domain B runs on four logical processors 104 (logical processors LP#B4 to LP#B7).

The OS 102 in the domain A assigns processes Pa0 to Pan to the logical processors LP#A0 to #A3. The OS 102 in the domain B assigns Pb0 to Pbn to the logical processors LP#B4 to #B7.

The hypervisor 105 switches the eight logical processors 104 by time sharing and assigns the eight logical processors 104 to four physical processors 101. Hence, the processes 103 are executed on the two OSes 102 by time sharing.

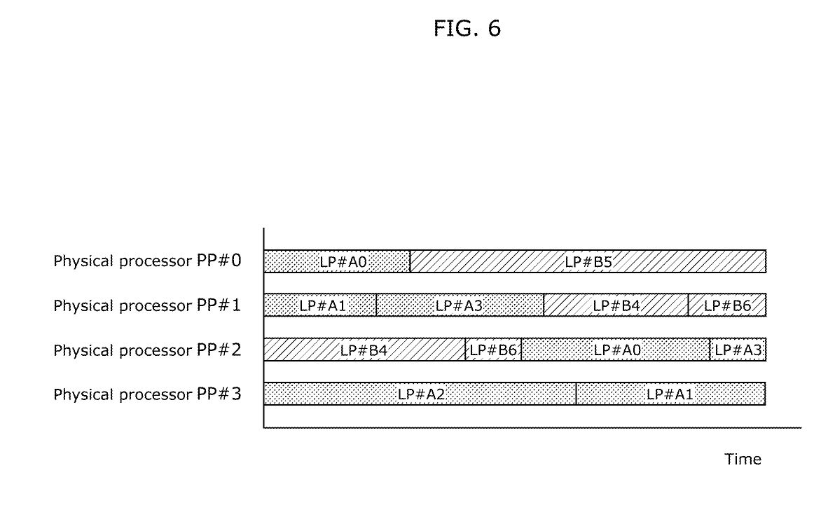

FIG. 6 shows how each of the logical processors 104 is assigned to one of the physical processors 101 by time sharing. To the physical processor PP#0, for example, the hypervisor 105 assigns the logical processor LP#A0 and then the logical processor LP#B5.

Moreover, a recent large scale integration (LSI) is highly integrated. Thus, large part of a system can be integrated into an LSI.

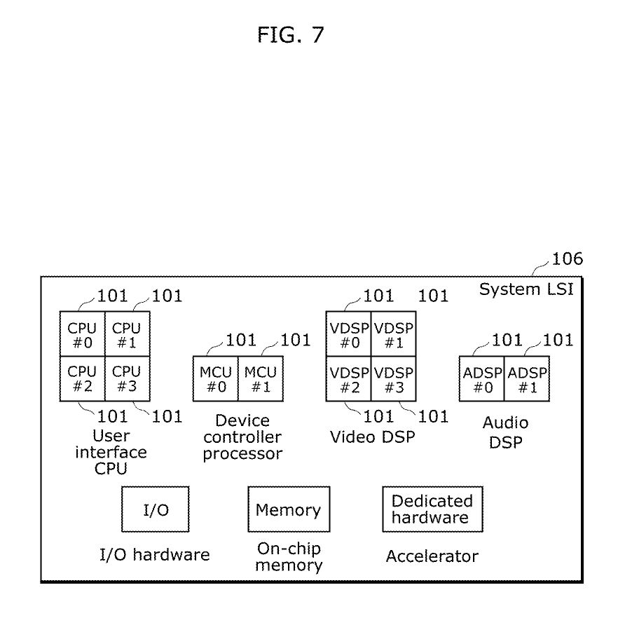

FIG. 7 depicts an exemplary LSI for a digital consumer appliance. As shown in the example, many processors with different structures and usage are integrated in a recent system LSI. Each of the processors is designed to optimally execute its own processing. Hence, the processor exercises the maximum capability in the field to which it is designated.

In a system LSI 106 in FIG. 7, for example, many physical processors 101 are integrated such as a user interface central processing unit (CPU), a device controller processor, a video digital signal processor (DSP), and an audio DSP.

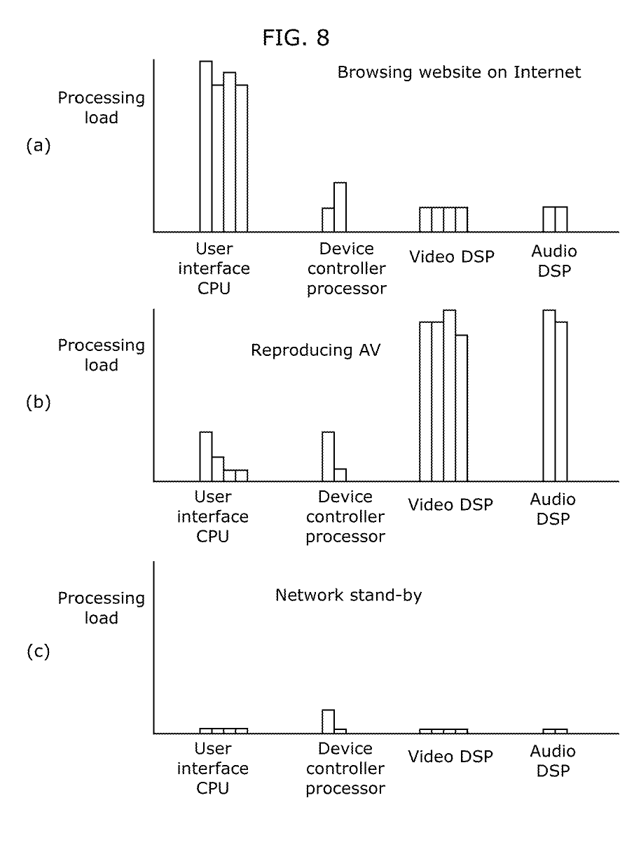

However, each of the physical processors 101 does not always operate with the maximum processing capability. As FIG. 8 exemplifies, in viewing a web browser on the Internet, in viewing audio/visual (AV) content on a digital TV, and in a stand-by status of a network, each of the processor groups operates with a different operation rate. In other words, as the illustration (a) in FIG. 8 shows, the processing load of an user interface CPU increases in viewing a Web browser on the Internet; however, the processing loads of the other CPUs are small. Moreover, as the illustration (b) in FIG. 8 shows, the processing loads of the video DSP and the audio DSP increase in viewing AV content; however, the processing loads of the other CPU are small. Furthermore, as the illustration (c) in FIG. 8 shows, the processing loads of all the CPUs are small when the network is on stand-by.

In a system, each of mounted processor groups is to individually provide a capability which requires maximum processing. Typically, such a feature inevitably causes an increase in cost.

In order to solve the cost problem and achieve high performance, the above-described virtual system has become in practical use. In other words, the virtual multiprocessor in FIG. 5 makes it possible to establish a system with high performance at a low cost.

In the virtual multiprocessor, however, various kinds of processing on multiple OS domains, each having a different processing load and processing characteristics, are executed together on the group of the physical processors 101. Such a problem hinders reduction of power consumption by efficient power control.

For example, the problem hinders active power reduction which is implemented with the technique in FIG. 4—that is to predict a power state based on the current operating statuses of other physical processors 101. Described hereinafter is the reason why.

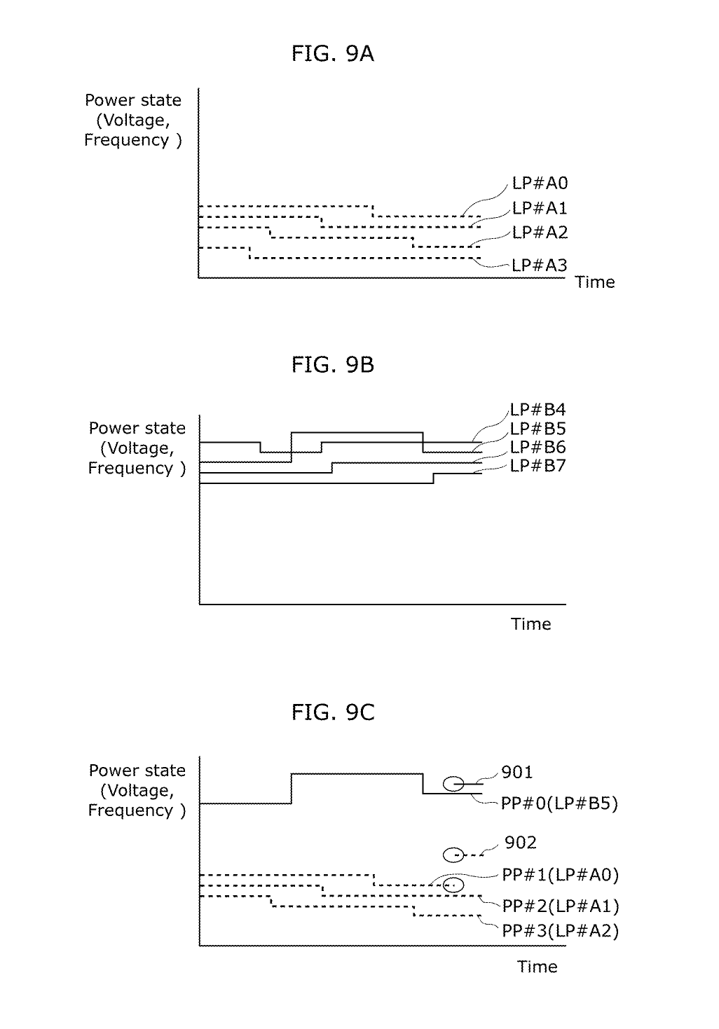

Suppose an exemplary virtual multiprocessor having two OS domains, as shown in FIG. 5. Of the two OS domains, suppose the case where the process 103 to be executed on the OS 102 in the domain A is light, and the process 103 to be executed on the OS 102 in the domain B is heavy. FIG. 9A exemplifies time transition of power states of the logical processors in the domain A. FIG. 9B exemplifies time transition of power states of the logical processors in the domain B. In both FIGS. 9A and 9B, the plot shows time as the abscissa and power state as the ordinate. As shown in FIG. 9A, the processes 103 to be executed on the logical processors LP#A0 to LP#A3 are light. As shown in FIG. 9B, the processes 103 to be executed on the logical processors LP#B4 to LP#B7 are heavy.

FIG. 9C exemplifies time transition of power states of the physical processors 101. The plot is the same as the ones in FIGS. 9A and 9B.

Here, suppose a period of time when the logical processor LP#B5 in the OS domain B for a high load is assigned to the physical processor PP#0, and the logical processors LP#A0 to #A2 in the OS domain A for a low load are respectively assigned to the physical processors PP#1 to PP#3.

A logical processor to be assigned to the physical processor PP#1 is switched from the logical processor LP#A0 in the low-load OS domain A to the logical processor LP#B4 in the high-load OS domain B. Here, application of the power state prediction based on the correlation between the physical processors 101, as shown in FIG. 4, would cause power control which is not essentially appropriate. In other words, originally, it is beneficial to activate the physical processor PP#1 in a high power state 901 since the physical processor PP#1 receives the logical processor LP#B4 in the high-load OA domain B. However, in the case where a power state is predicted based on the correlation between the physical processors 101, the prediction is significantly affected by low power states of the physical processors PP#1 to PP#3. Consequently, a low power state 902 is predicted. For example, in the case where the power state of the physical processor PP#1 is predicted based on the average between the high power state of the physical processor PP#0 and the low power states of the physical processors PP#1 to PP#3, the low power state 902 is inevitably predicted.

Such a prediction will cause an unnecessarily low frequency and voltage. Hence, necessary processing capabilities cannot be provided to the physical processors 101, causing deterioration in responsiveness for processing and real-time properties.

Another conceivable method for controlling a power state is to cause each of the logical processors 104 to hold the power state of its own. Then, using the last power state in which the hypervisor 105 was previously executed, for example, the method designates a power state as the predictive value of a power state in which the logical processor 104 is currently assigned to another physical processor 101.

The predicting method is appropriate for a single logical processor 104. In the case where power states are correlated between multiple logical processors 104, however, the method cannot take advantage of the correlation.

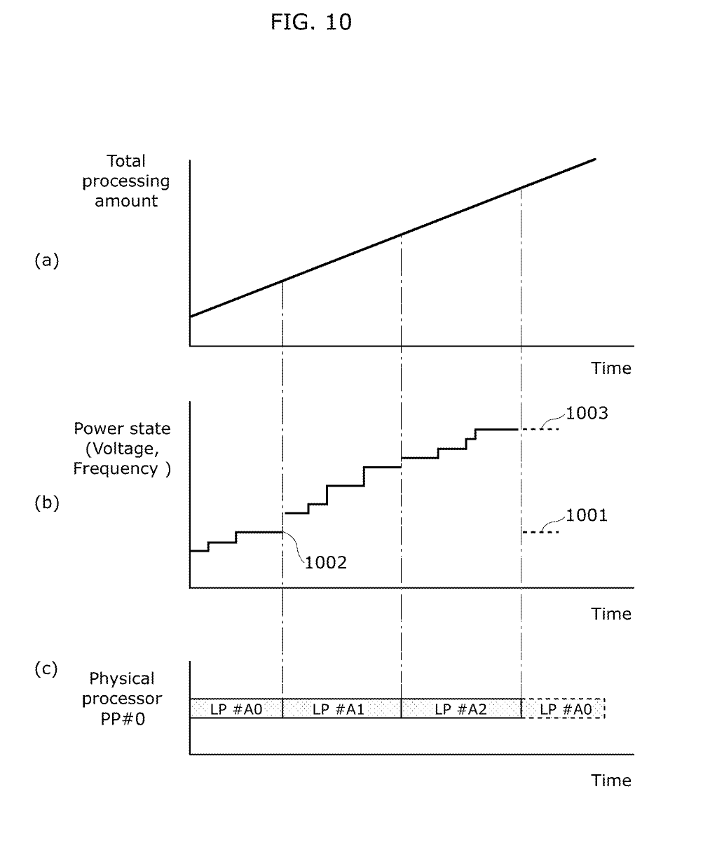

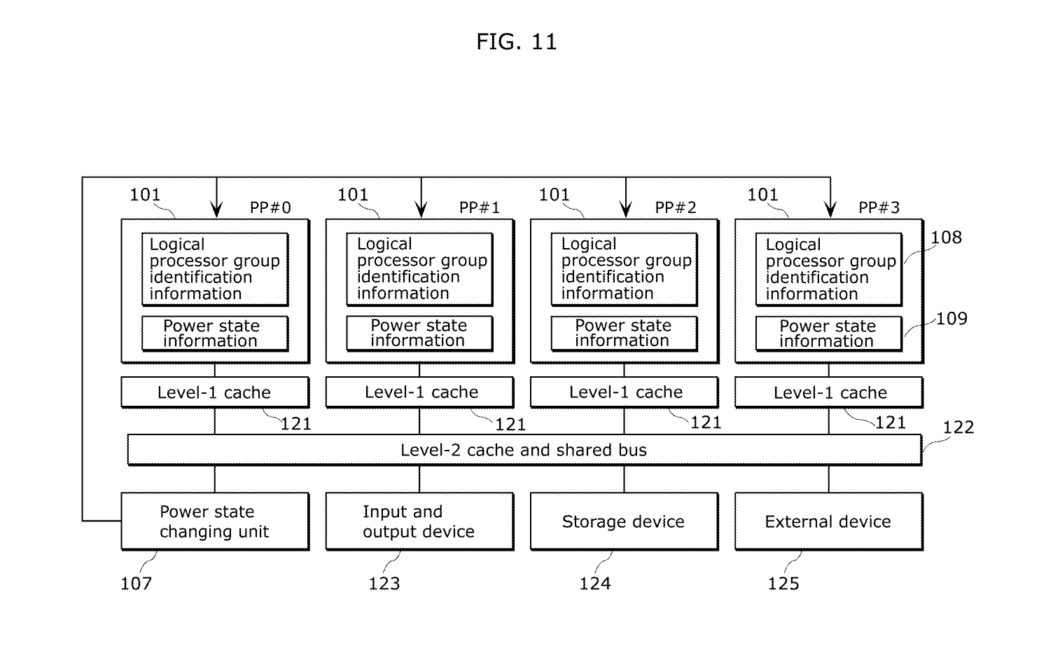

As shown in FIG. 10, for example, suppose the case where three of the logical processors LP#A0 to LP#A2 run on a single OS domain, and operate on the physical processor PP#0. This is associated with a case where a versatile OS is running on a symmetrical multiprocessor (SMP).

When a load increases because more processes have to be handled on the entire OS over temporal progress, as shown in the illustration (a) in FIG. 10, the power state of a logical processor 104 observed when the previous operation ended does not reflect the latest power state of the entire OS. In other words, as shown in the illustration (c) in FIG. 10, suppose the case where the physical processor PP#0 has the following logical processors 104 assigned thereto in the order: the logical processor LP#A0; the logical processor LP#A1; the logical processor LP#A2; and, again, the logical processor LP#A0. In this case, as shown in the illustration (b) in FIG. 10, the prediction for the power state will fail if a power state 1002 of the logical processor LP#A0 observed when the previous operation ended is designated as a power state 1001 of the logical processor LP#A0 observed when the current operation started.

In other words, when the logical processor LP#A0 is assigned again to the physical processor PP#0, it is a power state 1003 of the logical processor LP #A2 that reflects a more appropriate load state for the entire OS. However, the use of the previous power state 1002 of the logical processor LP#A0 cannot reflect the latest state of the OS, even though it is beneficial for the entire OS to finish the entire processing with appropriate power.

As described above, power consumption of the entire system cannot be sufficiently reduced as far as the power control is executed for each logical processor 104 or each physical processor 101.

Detailed hereinafter is an embodiment of the present disclosure, with reference to the drawings. It is noted that the same or a similar part among the drawings has the same reference sign, and the description thereof shall be omitted.

FIG. 11 depicts a block diagram showing a hardware structure of a multiprocessor system including a virtual multiprocessor according to the embodiment of the present disclosure. The multiprocessor according to the embodiment is to include microprocessors, microcomputers, micro controllers, and digital signal processors.

The multiprocessor system includes multiple physical processors 101 (physical processors PP#0 to PP#3), multiple level-1 caches 121, a level-2 cache and shared bus 122, a power state changing unit 107, an input and output device 123, a storage device 124, and an external device 125. Here, the physical processors 101, the level-1 caches 121, and the level-2 cache and shared bus 122 form a multiprocessor. It is noted that any other unit may be included in the multiprocessor.

The multiple physical processors 101 are connected each other via the level-2 cache and shared bus 122. Each of the physical processors 101 is connected to a corresponding one of the level-1 caches 121. Furthermore, through the level-2 cache and shared bus 122, the physical processors 101 are connected to the power state changing unit 107, the input and output device 123, the storage device 124, and an external device 125.

Each of the physical processors 101 holds logical processor group identification information 108 for identifying a logical processor group to which a logical processor 104 to be assigned to the physical processor 101 belongs. Hence, each of the physical processors 101 can check a logical processor 104 of which logical processor group is assigned to the physical processor 101. The logical processor groups are predetermined. The processing to be executed by the logical processors 104 that belong to the same processor group is determined so that the characteristics of the processing, such as required responsiveness to the processing and details of the processing, are similar each other.

Moreover, each of the physical processor 101 is to operate based on an operation voltage and an operation frequency corresponding to a power state indicated by the power state information 109.

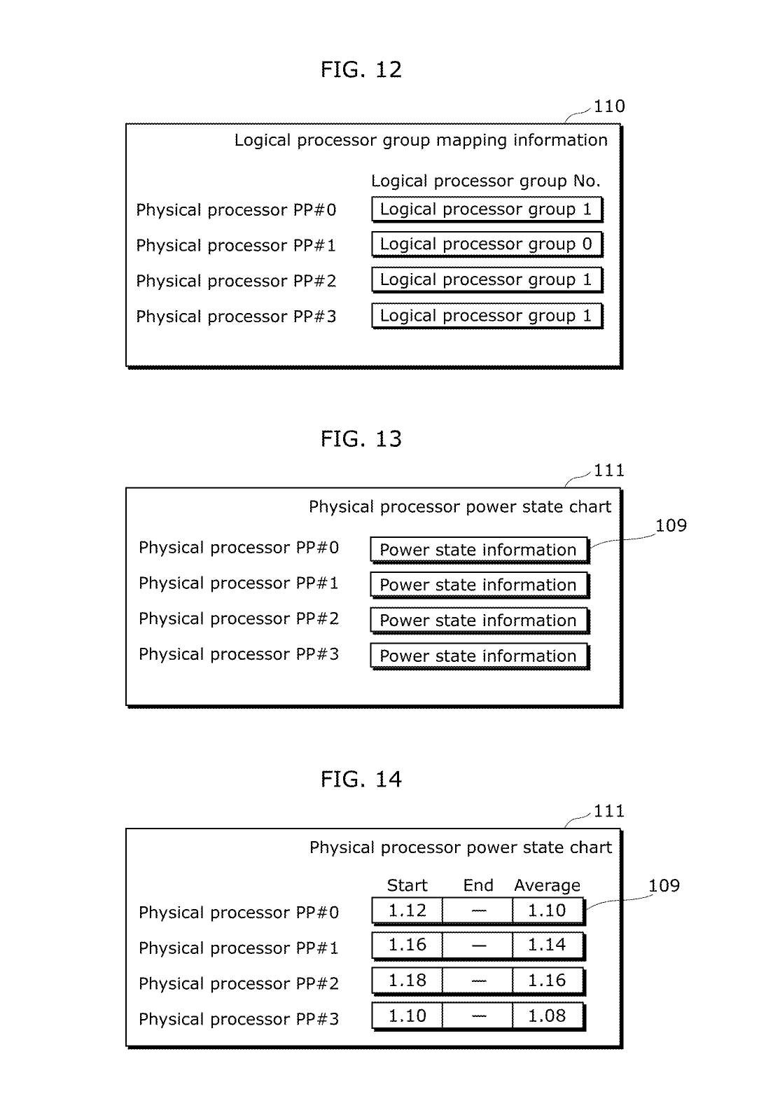

It is noted that the storage device 124 may store data indicating a correspondence relationship between the physical processors 101 and the logical processor groups. FIG. 12 exemplifies logical processor group mapping information which is data indicating a correspondence relationship between the physical processors 101 and the logical processor groups.

Logical processor group mapping information 110 stores, for each of the physical processors 101, the number of a logical processor group to which the logical processor 104 assigned to the physical processor 101 belongs. The logical processor group mapping information 110 in FIG. 12 shows that the logical processors 104 that belong to the logical processor group No. 1 are assigned to the physical processors PP#0, PP#2, and PP#3, and one of the logical processors 104 that belongs to the logical processor group No. 0 is assigned to the physical processor PP#1.

Similar to the logical processor group mapping information 110, the storage device 124 may store a physical processor power state chart 111 indicating the power state information 109 for each of the physical processors 101 as shown in FIG. 13.

FIG. 14 exemplifies the physical processor power state chart 111. The power state information 109 for each of the physical processors 101 includes: a power state observed when the assignment of a logical processor 104 starts; a power state observed when the assignment of the logical processor 104 ends; and the average power state observed during the assignment of the logical processor 104.

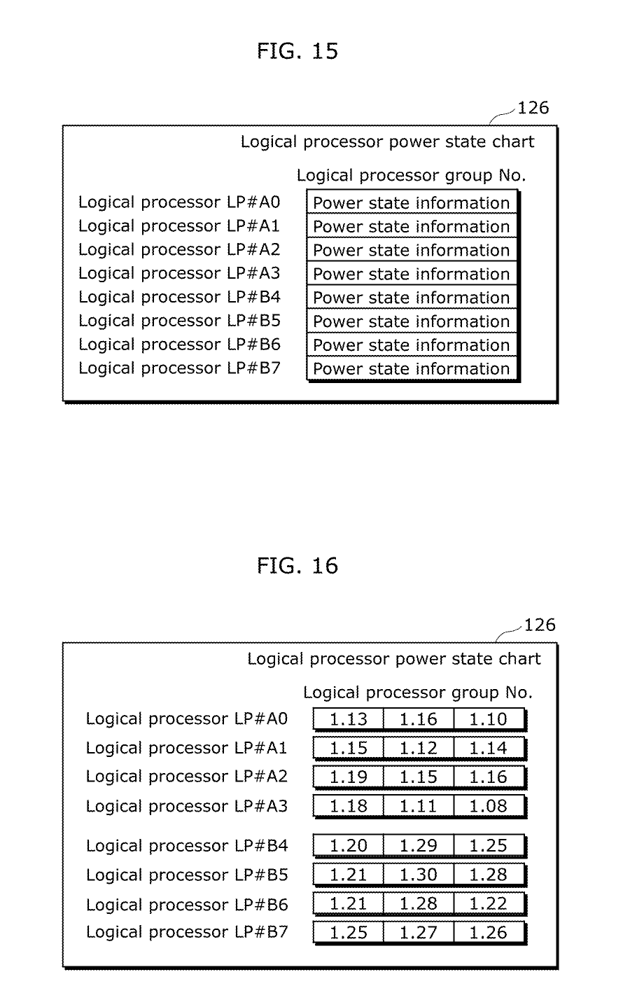

Furthermore, the storage device 124 is to store a logical processor power state chart 126 indicating power state information for each of the logical processors 104 as shown in FIG. 15. The power state of a logical processor 104 is a power state of either the physical processor 101 which is currently assigned to the logical processor 104 or the physical processor 101 which was assigned to the logical processor 104 most recently.

FIG. 16 exemplifies a logical processor power state chart 126. The power state information for each of the logical processors 104 includes: a power state observed when the assignment of the logical processor 104 starts; a power state observed when the assignment of logical processor 104 ends; and the average power state observed during the assignment of the logical processor 104.

The power state changing unit 107 changes a power state of each of the physical processors 101 according to a request from outside for changing the power state.

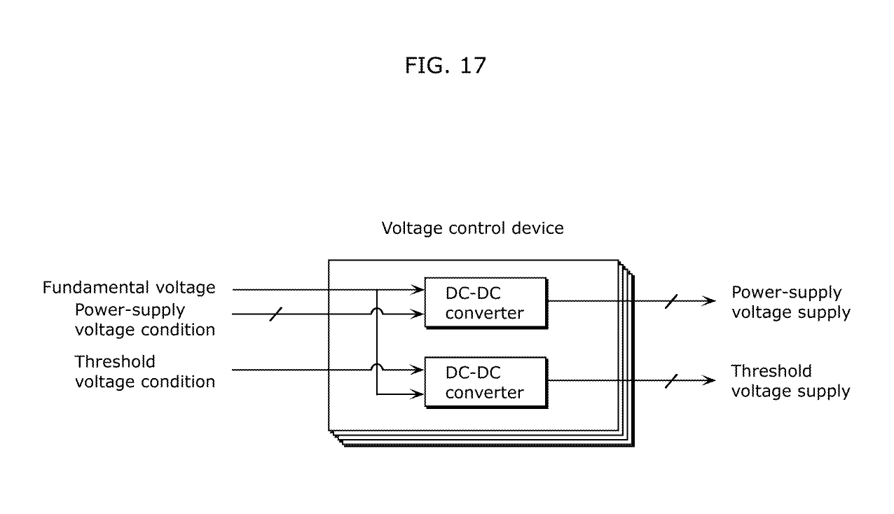

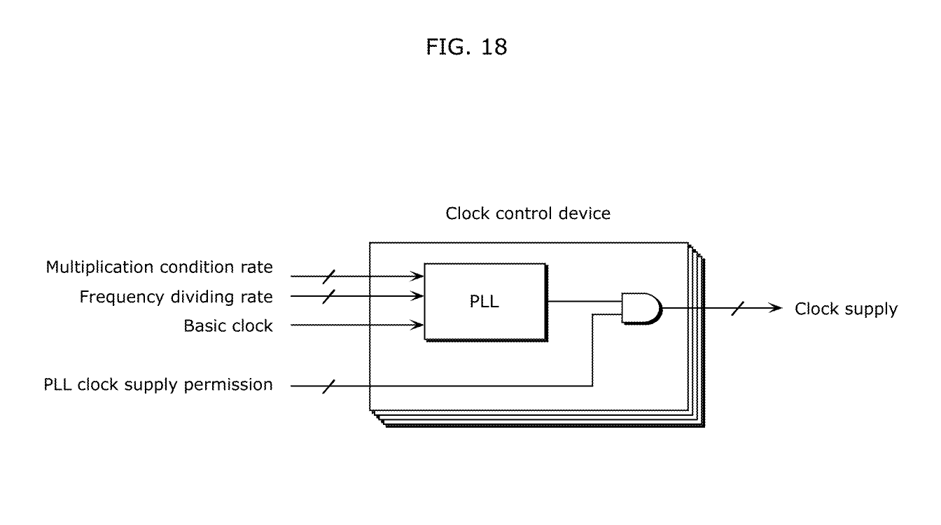

FIGS. 17 and 18 show an example of the power state changing unit 107. FIG. 17 depicts an exemplary circuit which uses a DC-DC converter to change a supply voltage under a given power-supply voltage condition and threshold voltage condition. FIG. 18 depicts an exemplary circuit which changes clock supplies based on a multiplication rate condition and a frequency dividing rate condition to be used as clock frequency information.

In other words, each of the circuits changes either a voltage value or a clock frequency for each of the physical processors 101 based on received power state change request information. The power state changing unit 107 may be mounted either on a single LSI as the group of the physical processors 101 is mounted or outside the LSI.

It is noted that the request to the power state changing unit 107 for changing a power state may be made by either hardware or software.

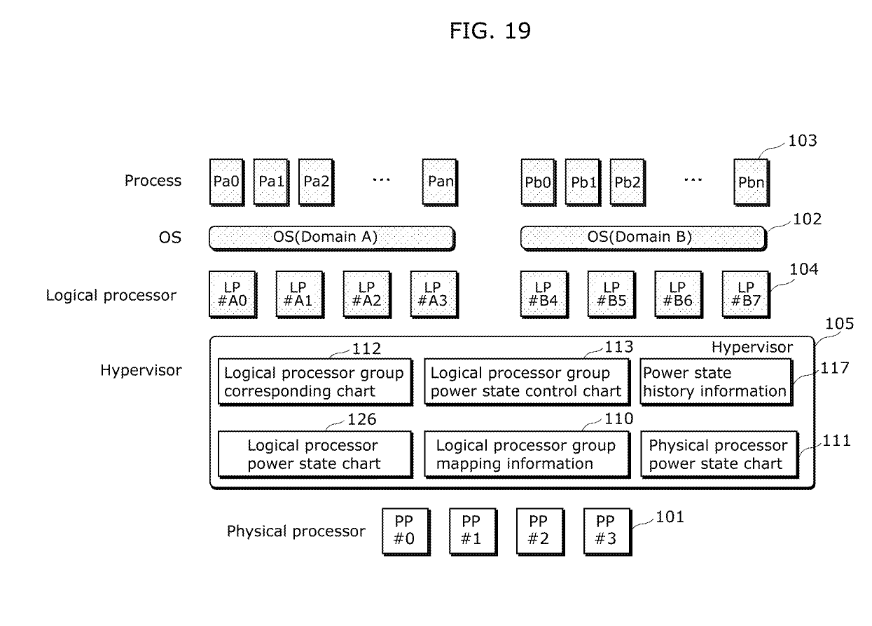

FIG. 19 depicts a hierarchy diagram showing a software structure for a power control method of the multiprocessor system shown in FIG. 11.

The hierarchy diagram is the same as the diagram showing the software structure of the virtual multiprocessor shown in FIG. 5.

It is noted that the hypervisor 105 includes a logical processor group corresponding chart 112, a logical processor group power state control chart 113, power state history information 117, the logical processor power state chart 126, the logical processor group mapping information 110, and the physical processor power state chart 111. Such information is stored in the storage device 124.

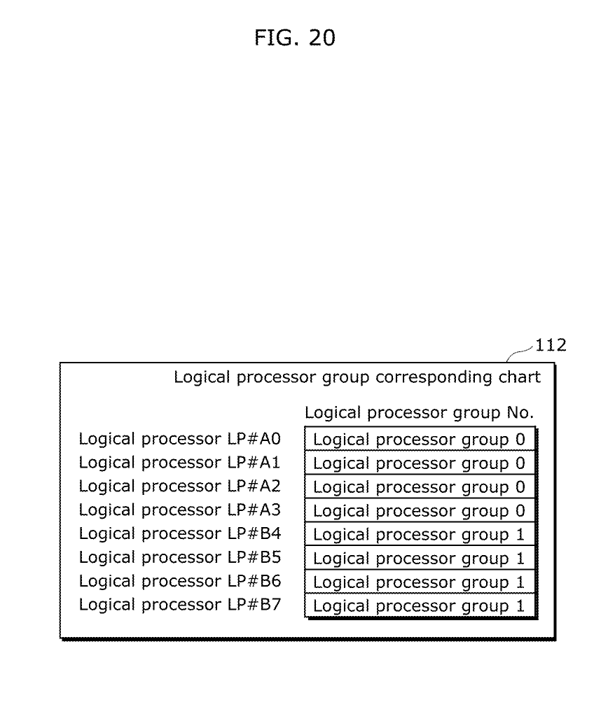

As shown in FIG. 20, the logical processor group corresponding chart 112 is data which associates the logical processors 104 with the logical processor groups. The example in FIG. 20 shows that the logical processors LP #A0 to LP#A3 belong to the logical processor group of the group No. 0 (the logical processor group 0), and the logical processors LP#B4 to LP#B7 belong to the logical processor group of the group No. 1 (the logical processor group 1).

A typical logical processor group is set so that the logical processors 104 that belong to an OS domain belong to the same logical processor group.

It is noted that, depending on the processing characteristics of a system, logical processor groups may be set so that logical processors 104 in an OS domain may belong to multiple logical processor groups and logical processors 104 in multiple OSes belong to a single logical processor group.

In view of software maintainability and security, eight logical processors 104 are grouped into two versatile OS domains formed of four logical processors 104. In one case, however, it would be desirable to apply the same power control to all the logical processors 104. In such a case, one logical processor group may be set so that eight logical processors 104 belong to the one logical processor group.

In contrast, there is another case where it would be desirable to designate power control characteristics only to a specific logical processor 104 in an OS domain. In such a case, a logical processor group may be set so that only the specific logical processor 104 belongs to the logical processor group.

Hence, depending on the characteristics of a system, any given relationship may be set between the logical processors 104 and the logical processor groups.

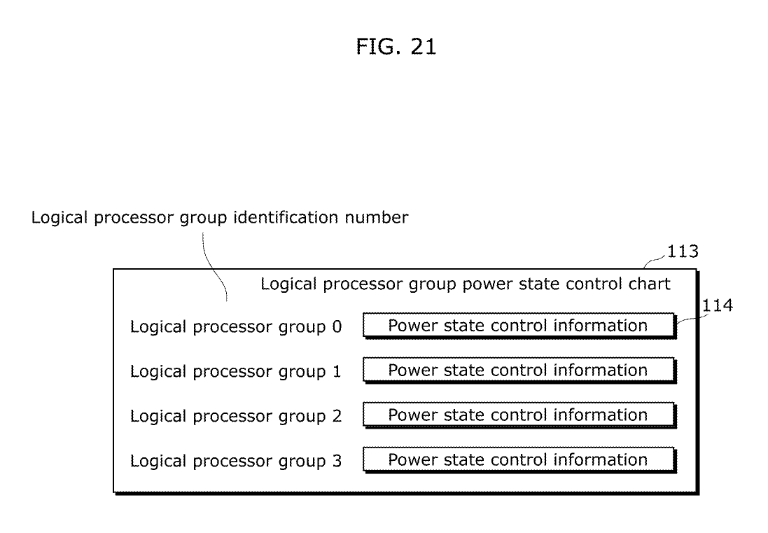

FIG. 21 shows an example of the logical processor group power state control chart 113. The logical processor group power state control chart 113 is data which stores power state control information 114 for each of the logical processor groups. The power state control information 114 is data indicating a power state and power control specifications of a logical processor group.

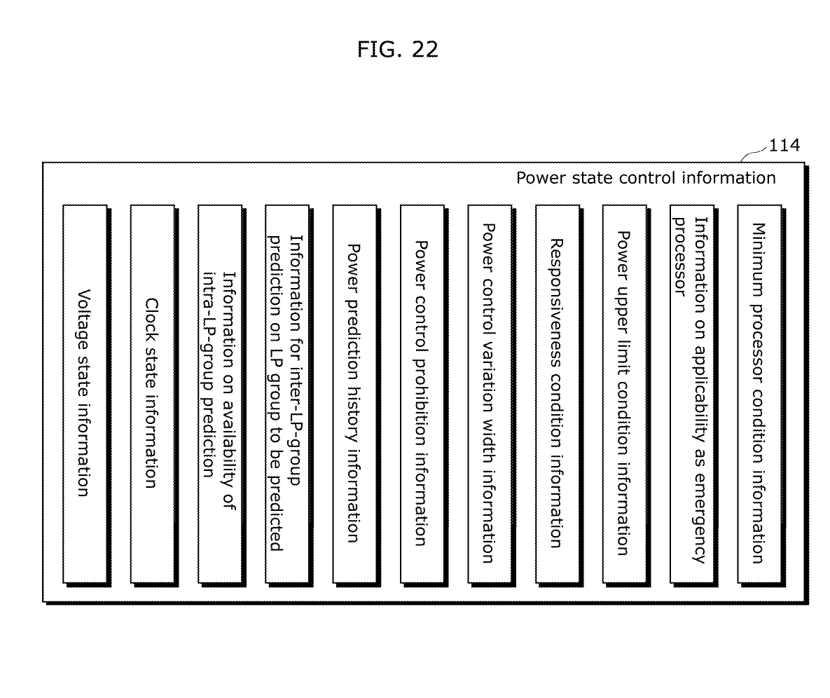

FIG. 22 shows an example of the power state control information 114.

The power state control information 114 includes: voltage state information; clock state information; information on availability of intra-LP-group prediction; information for inter-LP-group prediction on LP group to be predicted; power prediction history information; power control prohibition information; power control variation width information; responsiveness condition information; power upper limit condition information; information on applicability as emergency processor; and minimum processer condition information.

The voltage state information indicates a power state of a logical processor included in an intended logical processor group. The voltage state information includes, for example, a power-supply voltage and a threshold voltage.

The clock state information indicates a clock state of a logical processor included in an intended logical processor group. The clock state information includes, for example, a clock frequency and information indicating whether or not the current clock has stopped.

The information on availability of intra-LP-group prediction indicates, based on a power state of a logical processor 104 included in an intended logical processor group, whether or not the power state is to be predicted.

The information for inter-LP-group prediction on LP group to be predicted is identification information on one logical processor group so that the information identifies an intended logical processor group under the prediction for a power state as a single logical processor group as the one logical processor group. For example suppose a case where three OSes are running on a multiprocessor, two of the OSes are the same kind of OS and the other one is different from the two, and a logical processor group is set for each of the OSes. Here, the two logical processor groups corresponding to the same kind of OS are to be in the same logical processor group.

The power prediction history information indicates true or false of the prediction for a power state of a logical processor which belongs to an intended logical processor group. It is noted that, when a physical processor is activated with a logical processor assigned thereto under a predicted power state, the prediction is determined to be (i) true in the case where the predicted power state is maintained for a certain time period after the activation, and (ii) false in the case where the predicted power state is changed within the certain time period.

The power control prohibition information is flag information indicating whether or not the prediction for a power state is to be prohibited.

The power control variation width information indicates a variation width in changing power. A narrower variation width deteriorates responsiveness to power change, but allows fine power control. In contrast, a wider variation width makes it difficult to achieve fine power control, but contributes to great responsiveness to power change.

The responsiveness condition information indicates a level of responsiveness in power control. When a level with high responsiveness is desired, a voltage and a frequency are slowly lowered to obtain lower ones and quickly raised to obtain higher ones. Such operations are intended to raise the voltage and the frequency as high as possible, contributing to high responsiveness of a physical processor 101 to which a logical processor 104 that belongs to an intended logical processor group is assigned. It is noted that a variation width in changing power may be made wider when a level with higher responsiveness is desired.

The power upper limit condition information indicates the upper limit of power in power control. Setting a lower upper limit of the power allows the physical processors 101 to operate with lower power.

The information on applicability as emergency processor indicates whether or not a logical processor 104 which belongs to an intended logical processor group is an emergency processor. The emergency processor requires the highest responsiveness. When a logical processor 104 is designated as an emergency processor and assigned to a physical processor 101, the power state of the physical processor 101 is controlled raise the voltage and the frequency of the physical processor 101 highest.

The minimum processer condition information indicates the largest number of the logical processors 104 to be simultaneously assigned to multiple physical processors 101. The largest number is set low when the processing load of a process 103 to be executed by a logical processor 104 which belongs to a intended logical processor group is low, and thus high responsiveness is not required. Such a feature avoids an unproductive operation of a physical processor 101. While the physical processor 101 is not running, its power can be stopped.

The hypervisor 105 executes power control for a physical processor 101 based on each of the information items included in the above-described power state control information 114.

It is noted that the hypervisor 105 may be formed of one of (i) either software or hardware and (ii) both software and hardware so that the software and the hardware cooperate to execute processing.

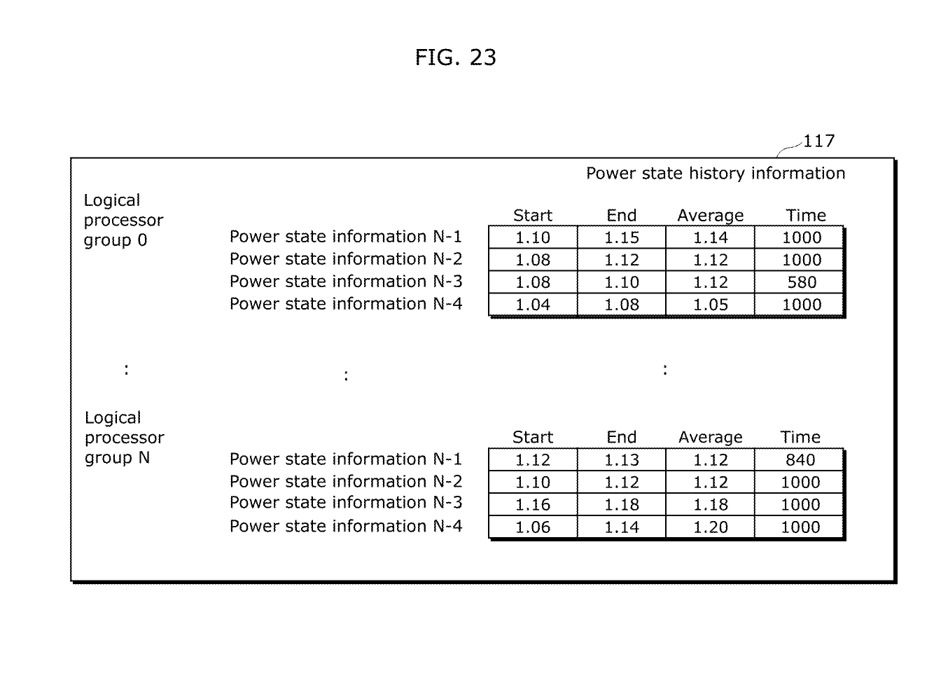

FIG. 23 shows an example of the power state history information 117.

The power state history information 117 employs first-in first-out (FIFO) to store power state information for each of the logical processor groups. The example in FIG. 23 shows that four power state information items (power state information N-1 to N-4) are stored as history. Each of the power state information items includes: a power state observed when the assignment of a logical processor 104 starts; a power state observed when the assignment of the logical processor 104 ends; and the average power state observed during the assignment of the logical processor 104.

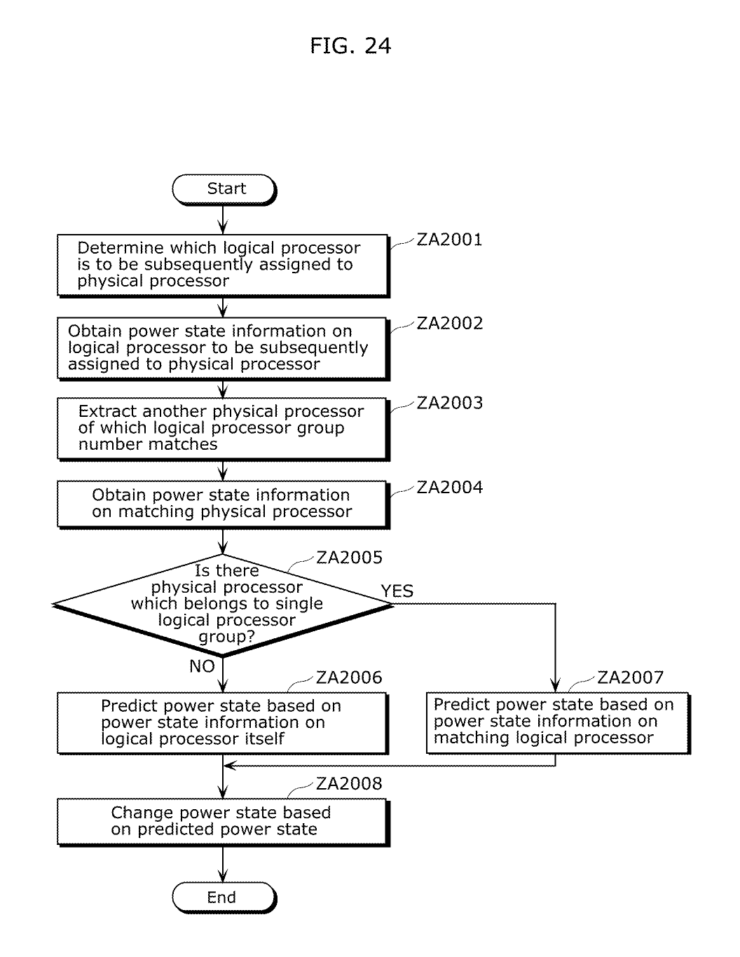

FIG. 24 depicts a flowchart of the power control method for the multiprocessor system according to the embodiment of the present disclosure.

In Step ZA2001, the hypervisor 105 determines which logical processor 104 is to be subsequently assigned to a physical processor 101. The determination of the logical processor 104 is executed through scheduling. The scheduling is not the primary focus of the present application, and thus the details thereof shall be omitted.

In Step ZA2002, the hypervisor 105 obtains from the logical processor power state chart 126 the power state information on the logical processor 104 to be subsequently assigned to the physical processor 101.

In Step ZA2003, the hypervisor 105 refers to the logical processor group mapping information 110 and extracts a physical processor 101 of which logical processor group number matches the logical processor group number of a logical processor group to which the logical processor 104 to be subsequently assigned to the physical processor 101 belongs.

In the following Step ZA2004, the hypervisor 105 obtains from the physical processor power state chart 111 the power state information 109 of the extracted physical processor 101.

In Step ZA2005, the hypervisor 105 determines whether or not there is a physical processor 101 of which logical processor group matches the logical processor group of the logical processor 104 to be subsequently assigned to the physical processor 101. In other words, the hypervisor 105 determines that the physical processor 101 exists in the case where the physical processor 101 is extracted in Step ZA2003, and the physical processor 101 does not exist in the case where the physical processor 101 cannot be extracted in Step ZA2003.

Next, in the case where there is no physical processor 101 of which logical processor group does not match the logical processor group of the logical processor 104 to be subsequently assigned to the physical processor 101 (Step ZA2005: NO), the hypervisor 105 predicts in Step ZA2006 a power state to be used based on previous power state information when the logical processor 104 is assigned to the physical processor 101. For example, the hypervisor 105 refers to the power state information obtained from the logical processor power state chart 126, and predicts a power state of the physical processor 101 observed when the logical processor 104 to be assigned is assigned most recently to the physical processor 101 as a power state to be used when the logical processor 104 to be assigned is assigned to the physical processor 101.

In the case where there is a physical processor 101 of which logical processor group matches the logical processor group of the logical processor 104 to be subsequently assigned to the physical processor 101 (Step ZA2005: YES), the hypervisor 105 predicts in Step ZA2007, based on the power state information 109 of the physical processor 101 obtained in Step ZA2004, a power state to be used when the logical processor 104 to be assigned is assigned to the physical processor 101. For example, the hypervisor 105 predicts the average value of the power states of the physical processors as a power state to be used when the logical processor 104 to be assigned is assigned to the physical processor 101.

In FIG. 9C, for example, suppose the case where the logical processor LP#B4 is assigned to the physical processor PP#1. Among the physical processors 101, only the physical processor PP#0 is in the logical processor group that matches the logical processor group of the logical processor LP#B4. Hence, the power state of the physical processor PP#0 is predicted as a power state to be used when the logical processor LP#B4 is assigned to the physical processor PP#1.

It is noted that, in predicting a power state, the prediction may be made based not only on a power state of a physical processor but also on a power state of a logical processor 104 to be assigned.

In step ZA2008, the hypervisor 105 requests the power state changing unit 107 to change the power state to the predicted power state, and based on the predicted power state, the power state changing unit 107 changes the power state of the physical processor 101 to which the logical processor 104 is to be assigned.

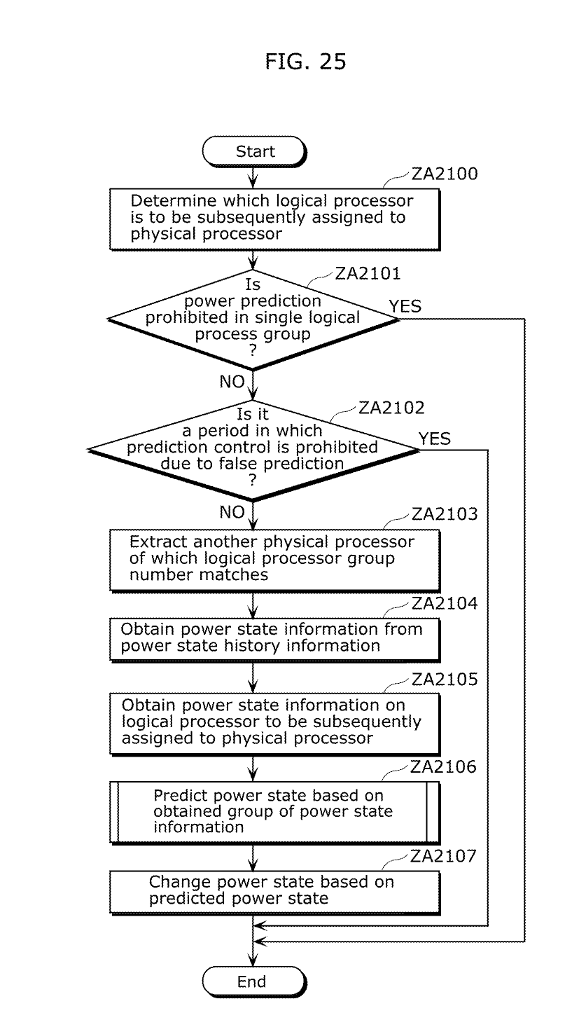

FIG. 25 depicts another flowchart of the power control method for the multiprocessor system according to the embodiment. The power control methods in FIGS. 24 and 25 are selectively executed. It depends on the design of the multiprocessor system which power control method is implemented.

In Step ZA2100, the hypervisor 105 determines which logical processor 104 is to be subsequently assigned to a physical processor 101. The determination of the logical processor 104 is executed through scheduling. The scheduling is not the primary focus of the present application, and thus the details thereof shall be omitted.

In Step ZA2101, the hypervisor 105 obtains from the logical processor group power state control chart 113 the power state control information 114 of the logical processor group to which a logical processor 104 to be assigned belongs. With reference to the information on availability of intra-LP-group prediction included in the obtained power state control information 114, the hypervisor 105 determines whether or not a power state prediction is prohibited among the logical processors 104 in the logical processor group.

In the case where the power state prediction is prohibited among the logical processors 104 (Step ZA2101: YES), the hypervisor 105 does not request power state changing unit 107 to change the power state, and maintains the power state of the current physical processor 101.

In the case where the power state prediction is not prohibited among the logical processors 104 (Step ZA2101: NO), the hypervisor 105 in Step ZA2102 refers to the power prediction history information included in the power state control information 114 obtained in Step ZA2101, and determines whether or not the prediction is false for the power state of the logical processor 104 which belongs to the above logical processor group.

In the case where it is a period in which a power control based on a power state prediction is prohibited due to the false prediction for the power state (Step ZA2101: YES), the hypervisor 105 does not request the power state changing unit 107 to change the power state, and maintains the power state of the current physical processor 101.

In the case where the prediction for the power state is true (Step ZA2101: NO), the hypervisor 105 in Step ZA2103 refers to the logical processor group mapping information 110 and extracts a physical processor 101 of which logical processor group number matches the logical processor group number of a logical processor group to which the logical processor 104 to be subsequently assigned to the physical processor 101 belongs.

In the following Step ZA2104, the hypervisor 105 obtains from the power state history information 117 the power state information on the logical processor group to which the logical processor 104 to be assigned belongs.

In Step ZA2105, the hypervisor 105 obtains from the logical processor power state chart 126 the power state information on the logical processor 104 to be subsequently assigned to the physical processor 101.

In Step ZA2106, based on the obtained group of power state information, the hypervisor 105 predicts a power state of a physical processor 101 to which a logical processor 104 is subsequently assigned. The details of the Step ZA2106 shall be described later.

In Step ZA2107, the hypervisor 105 requests the power state changing unit 107 to change the power state to the predicted power state, and based on the predicted power state, the power state changing unit 107 changes the power state of the physical processor 101 to which the logical processor 104 is to be assigned.

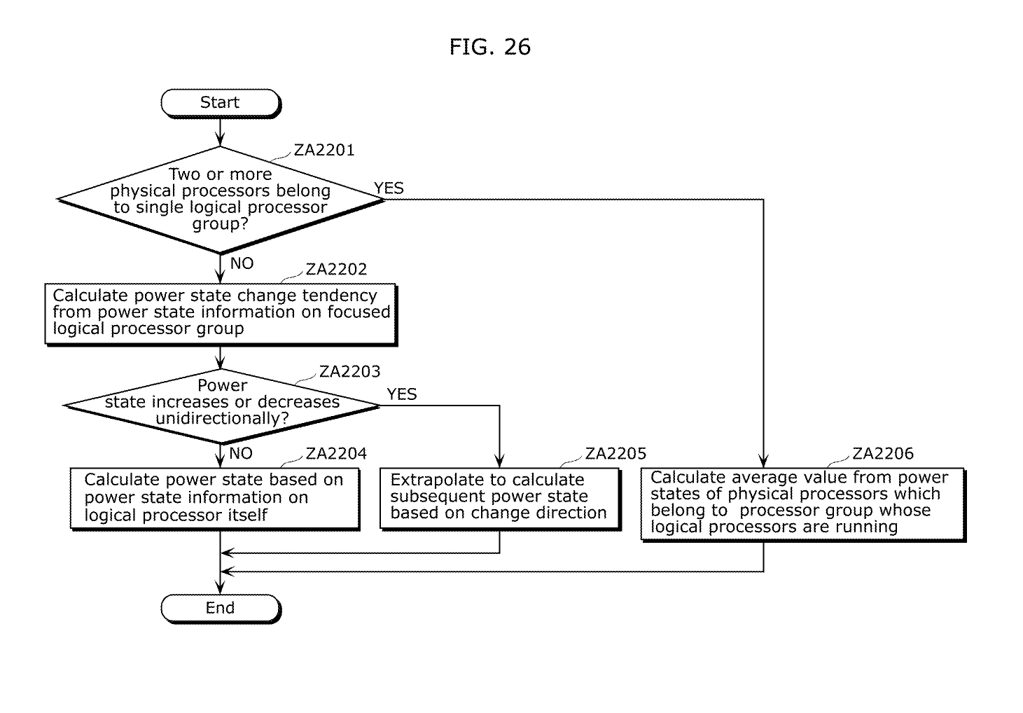

FIG. 26 depicts a flowchart showing details of power state prediction processing (the Step ZA2106 in FIG. 25).

In Step ZA2201, the hypervisor 105 refers to the logical processor group mapping information 110, and determines whether or not, among running physical processors 101, two or more of the running processors 101 belong to a logical processor group of assigned logical processors 104.

In the case where two or more physical processors 101 belong to a single logical processor group (Step ZA2201: YES), the hypervisor 105 predicts in Step ZA2206 the average value of the power states of the physical processors 101 that belong to the single logical processor group as a power state to be used when a logical processor 104 to be assigned is assigned to one of the physical processors 101. It is noted that the power states of the physical processors 101 are obtained from the physical processor power state chart 111. A specific example of the prediction is similar to the one in Step ZA2007 with reference to FIG. 9C.

Here, in order to reduce the effect of an error of a power state occurred in a moment, the basis of the determination is whether or not two or more physical processors 101 belong to a single logical processor group; however, this is just an example. Moreover, the exemplary prediction for a power state is based on the average value; instead, any given technique suitable to the system, such as weighted calculation, may be selected in predicting a power state.

In the case where only one physical processor 101 or none of the physical processors 101 belongs to a single logical processor group (Step ZA2201: NO), the hypervisor 105 calculates in Step ZA2202 a power state change tendency from the power state information in the power state history information 117 of a logical processor group to which a logical processor 104 to be assigned belongs.

For example, in the case where the power state history information 117 stores the past four histories and, as time progresses, all the histories show increasing power states—that is a tendency to show an increase in either voltage or frequency—the hypervisor 105 determines in Step ZA2203 that the power state is unidirectionally increasing. In contrast, in the case where all the histories show decreasing power states—that is a tendency to show a decrease in either voltage or frequency—the hypervisor 105 determines in Step ZA2203 that the power states are unidirectionally decreasing.

In the case where the hypervisor 105 determines that the power state change tendency is either unidirectionally increasing or unidirectionally decreasing (Step ZA2203: YES), the hypervisor 105 sets in the following Step ZA2205 a power state of a physical processor 101 so that the power state change tendency is maintained when the logical processor to be assigned is assigned to the physical processor 101. For example, the hypervisor 105 extrapolates, to predict, a power state of the subsequent physical processor 101 based on a value for four power states. Specifically, the hypervisor 105 may predict a power state of the subsequent physical processor 101 by least-squaring the value for four power states. For example, in the case of the example shown in FIG. 10, the physical processor 101 extrapolates a power state of the subsequent physical processor PP#0 from each of the power states of the past logical processors LP#A0, LP#A1, LP#A2 so as to predict a power state 1003 of the physical processor PP#0.

In other words, the hypervisor 105 can predict an appropriate power state in the case where a processing load is gradually increasing or decreasing in a logical processor group.

In the case where the power state change tendency is neither unidirectionally increasing nor unidirectionally decreasing—that is the case where the power state is changing at random—the hypervisor 105 predicts a power state to be used when a logical processor is assigned to a physical processor 101 based on the past power state information on the logical processor to be assigned. For example, the hypervisor 105 refers to the power state information obtained from the logical processor power state chart 126, and predicts a power state of the physical processor 101, observed when the logical processor 104 to be assigned was assigned most recently to the physical processor 101, as a power state to be used when the logical processor 104 to be assigned is assigned to the physical processor 101. Here, the hypervisor 105 cannot predict a power state based on a power state of another logical processor 104 included in a single logical processor group and on a power state of a running physical processor 101. However, the hypervisor 105 can prevent an increase in predictive errors by starting the processing at least from the most recent power state of the logical processor 104 to be assigned.

Hence, the hypervisor 105 can achieve more appropriate power state prediction control by predicting the subsequent power state with an appropriate combination of the latest power state of a physical processor 101 in the single logical processor group, a power state history of the same and most recent logical processor group, and the power state of a logical processor 104 to be assigned.

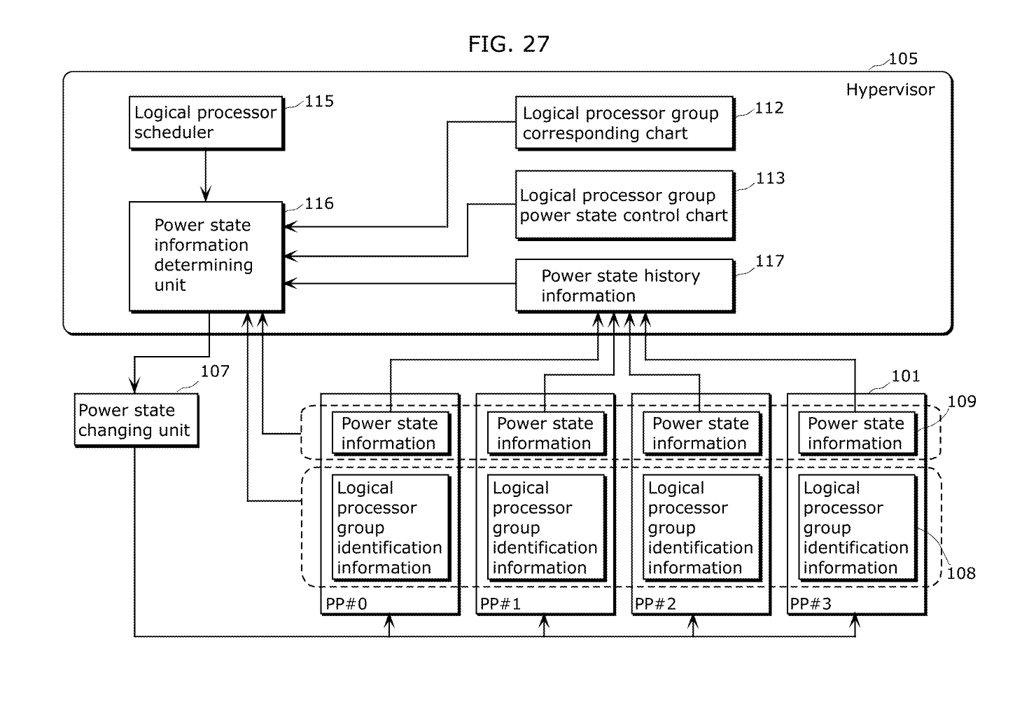

FIG. 27 depicts a diagram showing a logical operational relationship in the multiprocessor system according to the embodiment.

The hypervisor 105 implements itself as software. In executing the software, the hypervisor 105 functionally includes a logical processor scheduler 115, a power state information determining unit 116, the logical processor group corresponding chart 112, the logical processor group power state control chart 113, and the power state history information 117.

The hypervisor 105 and the power state changing unit 107 operate as a power control device. The power control device controls the power consumption of the physical processors 101 in virtual processors in which multiple logical processors 104 are each assigned to one of the physical processors 101 by time sharing to execute processes on the logical processors 104. Here, the power consumption dynamically changes depending on a processing amount. The logical processors 104 are grouped in into multiple logical processor groups.

When a logical processor 104 to be assigned to a physical processor 101 is replaced with another logical processor 104, and based on power state information indicating power consumption of another physical processor 101 to which the logical processors 104 that belong to a target logical processor group area assigned, the power state information determining unit 116 determines power state information to be used when the replacing logical processor 104 is assigned to the physical processor 101. Here, the target processor group is one of the logical processor groups and including the replacing logical processor 104.

The power state changing unit 107 changes power to be supplied to the physical processors 101 based on the power state information determined by the power state information determining unit 116.

Exemplified below is an operation for predicting a power state.

Each of the physical processors 101 updates the power state information 109 based on the change in a power state such as the power-supply voltage and the operation frequency of the physical processor 101.

The logical processor scheduler 115 executes scheduling processing for assigning a logical processor 104 to a physical processor 101.

When the scheduling of the logical processor 104 is newly executed by the logical processor scheduler 115 and a logical processor 104 is replaced with another one on a physical processor 101, the power state information 109 of the physical processor 101 is written in the power state history information 117.

The power state history information 117 can store any given numbers of the power state information 109 items. When a new power state information 109 item is written in the power state history information 117, the least recent power state information 109 item is pushed out and deleted.

In contrast, when the scheduling of the logical processor 104 is executed and a new logical processor 104 to be assigned to the physical processor 101 is confirmed, the power state information determining unit 116 identifies, based on the logical processor group corresponding chart 112, a logical processor group to which the logical processor 104 belongs.

Furthermore, based on the logical processor group mapping information 110, the power state information determining unit 116 identifies, from among the currently running physical processors 101, physical processors 101 included in a single logical processor group.

The power state information determining unit 116 obtains the power state information 109 from the physical processors 101 included in the single logical processor group.

The power state information determining unit 116 predicts the subsequent power state based on the obtained power state information 109 and the power state history information 117, of the logical processors 104 to be assigned, for each of such logical processors 104.

Based on the predicted power state, the power state information determining unit 116 causes the power state changing unit 107 to generate a power state change request and update the power of a physical processor 101 which the power state changing unit 107 is handling.

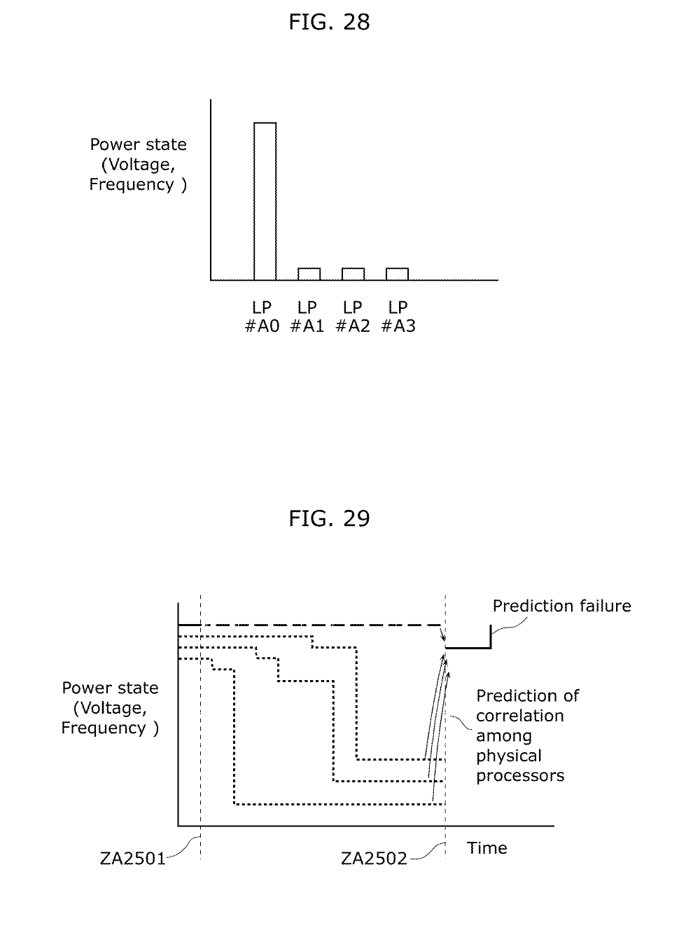

Described below with reference to FIG. 28 is why power state prediction is prohibited, based on power states of logical processors 104 included in a single logical processor group based on the information on availability of intra-LP-group prediction in the power state control information 114 shown in FIG. 22.

FIG. 28 shows power states of four logical processors 104 (the logical processors LP#A0 to LP#A3) included in a single logical processor group.

For example, this is a case where, on an OS, only one process is executed with a high load and the other processes are not activated. For example, this is a case where the only running process is the one for data processing software with a high load executed in the background.

Here, a power state could be predicted using the power states of the logical processors 104 included in a single logical processor group; however, the prediction is influenced by the power states of logical processors 104 which are not handling the processing.

Consequently, the power state of the logical processor 104 with the high load will be faultily predicted to be low. Alternatively, the prediction is influenced by the power state of the logical processor 104 with the high load. Consequently, the power states of the logical processors 104 with a low load will be faultily predicted to be high. These are not beneficial as power states for a multiprocessor system.

The problem of the faulty predictions can be prevented when, on each OS level (for each logical processor group), an occurrence of an apparent imbalance among the loads is detected from the load states of the logical processors 104, and the information on availability of intra-LP-group prediction in the logical processor group power state control chart 113 is set to the prohibition mode via the hypervisor 105.

A typical OS can manage the number of processes and the idling state of the each process. Hence, by diverting a function of any available OS, reflection of the load states can be implemented with a cooperation of the hypervisor 105.

Moreover, depending on systems, there are some cases where an imbalanced load state would be previously detected for each of processes in an OS. One of such cases is, for example, burst device control which sporadically occurs. Here, the designer of the system software previously may set the power state prediction, which is based on the power states of the logical processors 104 in a logical processor group, to the prohibition mode. Such a setting can reduce the effect of an essentially-undesirable power state prediction.

Described next with reference to FIG. 29 is a power state prediction based on the power prediction history information included in the power state control information 114 shown in FIG. 22.

FIG. 29 shows time transition of the power states of four logical processors 104 running on a physical processor 101 and included in a single logical processor group.

At the time ZA2501, a logical processor 104 having the greatest power state is pushed out of the physical processor 101. Then, after that, the power state prediction is made at the time ZA2502 when the saved logical processor 104 is reassigned to the physical processor 101.

Here, at the time ZA2502, three of the logical processors 104 included in the single logical processor group are executing the processes 103, and all the three logical processors 104 are making a transition to a low-load state. When assigning the fourth logical processor 104 to the physical processor 101, the hypervisor 105 predicts the power state of the fourth logical processor 104 based on the power states of the three logical processors 104 executing the processes 103. Such a prediction causes the power state of the fourth logical processor 104 to be set lower than the previous operating power state of the fourth logical processor 104 itself.

However, as shown in the above-described example in FIG. 28, the fourth logical processor 104 is incidentally executing the only process 103 having a high load. In the case where the power state needs to be higher than the predicted and set power state, the prediction of the power state prediction is regarded as failure.

Repetition of such prediction failures could cause a loss of processing time due to unavailability of a frequency required for processing at an appropriate time zone, in addition to a power loss. For some applications which require a high real-time property, the loss of the processing time cannot be tolerated.

Hence, in the case where a physical processor 101 causes, within a predetermined time period following an assignment of a logical processor 104 to the physical processor 101, a prediction failure in which a predicted power state differs from a required power state after the prediction, the hypervisor 105 sets the power state prediction to the prohibition mode for the logical processor group to which the logical processor 104 assigned to the physical processor 101 belongs. In the active mode setting for the power state prediction, the hypervisor 105 can set the power state prediction to the prohibition mode when prediction failures occur for a predetermined number of times. Then, the hypervisor 105 allows the prediction again after the elapse of the predetermined time period or through setting by the software.

Such a feature makes it possible to achieve a more active power state prediction while minimizing software intervention.

As described above, the multiprocessor system according to the embodiment separates logical processors 104 into groups in each of which the grouped logical processors 104 are mutually correlated so that the grouped logical processors 104 execute processing on a comparable level. Then, based on power state information on logical processors 104 which belong to the same logical processor group as the logical processor group to which a logical processor 104 to be assigned to a physical processor 101 belongs, the multiprocessor system determines the power state information on the physical processor 101 to which the logical processor 104 is assigned. Hence, even though processing loads differ among multiple logical processors 104 each to be assigned to one of the physical processors 101 by time sharing, the multiprocessor system can follow the change of a processing load due to switching logical processors 104 and implement optimum power control.

Described above is the multiprocessor system according to the embodiment of the present disclosure. The present disclosure shall not be limited to the embodiment.

For example, there may be one physical processor 101.

In the above embodiment, when the power states of the physical processors 101 are predicted based on the power states of the logical processors 104, the predictions are made through calculation; however, the predictions shall not necessarily be limited to calculation. For example, the power states of the physical processors 101 may be determined by classifying the power states of the logical processors 104 to be used for the predictions into levels, and, for each of the levels, referring to table data indicating the power states of the physical processors 101 when the physical processors are activated.

Based on (i) power state information on a logical processor which belongs to a logical processor group indicated by the information for inter-LP-group prediction on LP group to be predicted included in the power state control information 114 in FIG. 22 and (ii) power state information on a logical processor which is different from the replacing logical processor and included in logical processors that belong to a target processor group to which another replacing logical processor belongs, the power state information determining unit 116 may determine the power state information on the replacing logical processor.

Based on (i) the power state information on the logical processor which is included in the logical processors that belong to the target logical processor group and is different from the replacing logical processor and (ii) responsiveness condition information for the target logical processor group included in the power state control information 114 in FIG. 22, the power state information determining unit 116 may determine the power state information on the replacing logical processor. Here, the power state information indicates that the power is greater as responsiveness indicated by the responsiveness condition information is higher.

When the information on applicability as emergency processor requests the highest responsiveness for the target logical processor group included in the power state control information 114 in FIG. 22, the power state information determining unit 116 may determine a possible maximum value for the power state information as a value indicated by the power state information on the replacing logical processor.

It is noted that the present disclosure may be the methods described above. Moreover, the method may be implemented in the form of a computer program executed on a computer and of digital signals included in the computer program.

Furthermore, the present disclosure may also be implemented in the form of the computer program or the digital signals stored in non-transitory computer-readable recording media such as a flexible disc, a hard disk, a CD-ROM, an MO, a DVD, a DVD-ROM, a DVD-RAM, a BD (Blu-ray Disc, Registered), and a semiconductor memory. Moreover, the present disclosure may be the digital signals stored in the non-transitory computer-readable recording media.

In addition, the present disclosure may also be implemented in the form of the aforementioned computer program or digital signals transmitted via a telecommunication line, a wireless or wired communication line, a network represented by the Internet, and data broadcast.

The present disclosure may also be a computer system including a microprocessor and a memory, in which the memory stores the aforementioned computer program and the microprocessor operates according to the computer program.

Furthermore, the above program or the above digital signals may be recorded on the above non-transitory computer-readable recording media for their transportation or transmitted via the above network in order to be utilized on another independent computer system.

The herein disclosed subject matter is to be considered descriptive and illustrative only, and the appended Claims are of a scope intended to cover and encompass not only the particular embodiment disclosed, but also equivalent structures, methods, and/or uses.

### INDUSTRIAL APPLICABILITY

An exemplary embodiment of the present disclosure is applicable to information processing systems including multiprocessors, such as a micro processor, a micro computer, a micro controller, and a digital signal processor.

1. A power control device which controls power consumption of a physical processor in a virtual processor in which logical processors are each assigned to the physical processor by time sharing to execute processes on the logical processors, the power consumption dynamically changing depending on a processing amount,
wherein the logical processors are grouped into logical processor groups,
the power control device comprising:
a power state information determining unit configured to, when one of the logical processors assigned to the physical processor is replaced with another one of the logical processors, and based on power state information indicating power consumption of another physical processor to which the logical processors that belong to a target logical processor group are assigned, determine power state information to be used when the replacing logical processor is assigned to the physical processor, the target logical processor group being one of the logical processor groups and including the replacing logical processor; and
a power state changing unit configured to change power to be supplied to the physical processor based on the power state information determined by the power state information determining unit.

2. The power control device according to claim 1,
wherein the power state information determining unit is configured to determine the power state information on the replacing logical processor based on power state information on a logical processor which is (i) included in the logical processors that belong to the target logical processor group and (ii) different from the replacing logical processor.

3. The power control device according to claim 2,
wherein the power state information determining unit is configured to determine an average value indicated by the power state information on the different logical processor as a value indicated by the power state information on the replacing logical processor.

4. The power control device according to claim 2, further comprising
a power state control information storage unit configured to store intra-logical-processor-group prediction permission information indicating, in determining for each of the logical processor groups power state information on a logical processor which belongs to the each logical processor group, permission of a use of power state information on a logical processor which belongs to the each logical processor group and is different from a logical processor to be assigned to the physical processor,
wherein, with reference to the intra-logical-processor-group prediction permission information stored in the power state control information storage unit, the power state information determining unit is configured to determine the power state information on the replacing logical processor based on the power state information on a logical processor which is (i) included in the logical processors that belong to the target logical processor group and (ii) different from the replacing logical processor, only when intra-logical-processor-group prediction permission information indicates the permission.

5. The power control device according to claim 4,
wherein the power state information determining unit is configured to determine an average value indicated by the power state information on the different logical processor as a value indicated by the power state information on the replacing logical processor.

6. The power control device according to claim 2, further comprising
a power state control information storage unit configured to store information for inter-logical-processor-group prediction on logical processor group to be predicted which (i) is referred to in determining for each of the logical processor groups power state information on a logical processor which belongs to the each logical processor group and (ii) indicates a logical processor group that is different from the each logical processor group,
wherein the power state information determining unit is configured to determine the power state information on the replacing logical processor based on (i) power state information on a logical processor included in the logical processors and belongs to the logical processor group indicated by the information for inter-logical-processor-group prediction on logical processor group to be predicted and (ii) power state information on a logical processor which is (i) included in the logical processors that belong to the target logical processor group and (ii) different from the replacing logical processor.

7. The power control device according to claim 1,
wherein the power state information determining unit is configured to determine the power state information on the replacing logical processor based on previous power state information on the replacing logical processor.

8. The power control device according to claim 1,
wherein, when values which are indicated by the previous power state information on the logical processors that belong to the target logical processor group and are assigned to the other physical processor are monotonically increase or decrease over temporal progress, the power state information determining unit is configured to determine the power state information on the replacing logical processor by extrapolating the values.

9. The power control device according to claim 1, further comprising
a power state control information storage unit configured to store power prediction history information indicating whether or not the power state information on the physical processer is true, the power state information being determined for each of the logical processor groups when a logical processor which belongs to the each logical processor group is assigned to the physical processor,
wherein, with reference to the power prediction history information stored in the power state control information storage unit, the power state information determining unit is configured to determine the power state information on the replacing logical processor only when the power state information on the other physical processor for the target logical processor group is true.

10. The power control device according to claim 1, further comprising
a power state control information storage unit configured to store for each of the logical processor groups condition information indicating responsiveness of processing to be executed by a logical processor which belongs to the each logical processor group,
wherein, based on (i) power state information on a logical processor which is included in the logical processors that belong to the target logical processor group and is different from the replacing logical processor and (ii) the condition information for the target logical processor group stored in the power state control information storage unit, the power state information determining unit is configured to determine the power state information on the replacing logical processor, the power state information indicating that power is greater as the responsiveness indicated by the condition information is higher.

11. The power control device according to claim 1, further comprising
a power state control information storage unit configured to store for each of the logical processor groups information on applicability as emergency processor indicating whether or not highest responsiveness is required for processing to be executed by a logical processor which belongs to the each logical processor group,
wherein, when the information on applicability as emergency processor requests the highest responsiveness for the target logical processor group stored in the power state control information storage unit, the power state information determining unit is configured to determine a possible maximum value for power state information as a value indicated by the power state information on the replacing logical processor.

12. A power control method for controlling power consumption of a physical processor in a virtual processor in which logical processors are each assigned to the physical processor by time sharing to execute processes on the logical processors, the power consumption dynamically changing depending on a processing amount,
wherein the logical processors are grouped in into logical processor groups,
the power control method comprising:
when one of the logical processors assigned to the physical processor is replaced with another one of the logical processors, and based on power state information indicating power consumption of another physical processor to which the logical processors that belong to a target logical processor group are assigned, determining power state information to be used when the replacing logical processor is assigned to the physical processor, the target logical processor group being one of the logical processor groups and including the replacing logical processor; and
changing power to be supplied to the physical processor based on the determined power state information.

13. A non-transitory computer-readable recording medium for use in a computer, the recording medium having a computer program recorded thereon for causing the computer to execute on a physical processor for controlling power consumption of the physical processor in a virtual processor in which logical processors are each assigned to the physical processor by time sharing to execute processes on the logical processors, the power consumption dynamically changing depending on a processing amount,
wherein the logical processors are grouped in into logical processor groups,
when one of the logical processors assigned to the physical processor is replaced with another one of the logical processors, and based on power state information indicating power consumption of another physical processor to which the logical processors that belong to a target logical processor group are assigned, determining power state information to be used when the replacing logical processor is assigned to the physical processor, the target logical processor group being one of the logical processor groups and including the replacing logical processor; and
changing power to be supplied to the physical processor based on the determined power state information.
